(19) United States
(12) Patent Application Publication
(10) Pub. No.: US 2005/0031797 A1
(43) Pub. Date: Feb. 10, 2005

(54) Method and apparatus for forming hard carbon film

(76) Inventor: Hideaki Matsuyama, Tokyo (JP)

Correspondence Address: RABIN & Berdo, PC, 1101 14TH STREET, NW, SUITE 500, WASHINGTON, DC, 20005, US

(21) Appl. No.: 10/878,476

(22) Filed: Jun. 29, 2004

(30) Foreign Application Priority Data
Jul. 1, 2003 (JP) JP PA 2003-270173

(51) Int. Cl. H05H 1/24

(52) U.S. Cl. 427/569; 427/282; 118/715

(57) ABSTRACT

A method and an apparatus for forming a hard film, such as a hard carbon film, using only ions in a plasma. A shielding member in the form of a magnet is disposed between a plasma source and a substrate. A plasma CVD method is applied for decomposing a raw material in the plasma. The film is formed from the decomposed material.

### BACKGROUND OF THE INVENTION

1. Field of the Invention

The invention relates to a method of forming a hard carbon film used as a coating of a sliding resistant member or wear resistance member of each of various kinds of metal molds, mechanical parts, tools, etc. and as a protection film of a magnetic recording medium, and an apparatus used for the method.

2. Background Art

When sliding resistant members and wear resistance members for various kinds of metal molds, mechanical parts, and tools are manufactured, various kinds of hard coatings are coated on the surfaces of substrates formed of super alloy or ceramic materials from the viewpoint of high-quality and/or long lifetime of products. Furthermore, it is also general to coating the surface of a magnetic recording medium such as a hard disc or the like with a hard coating as a protection film.

Diamond-like carbon (DLC) film based on a plasma CVD method or sputtering method is known as a hard coating using carbon among the hard coatings used for the above purpose. In this technique, a film of 10 GPa or more in hardness is called as the DLC film. Furthermore, the DLC film is more excellent in surface smoothness as compared with polycrystalline thin film such as titan nitride or the like because it is amorphous and has no crystal grain boundary, and thus it is a suitable material as a surface coating. Therefore, the DLC film is generally used as a protection film of a magnetic recording medium by taking advantage of such a characteristic as described above, and also it is known as a film providing excellent an sliding characteristic even though it may have a film thickness of 100 nm or less.

Recently, it has been required from the market side to further enhance the sliding resistance performance and the wear resistance performance. Further, hard coatings that are more excellent in sliding resistance performance and wear resistance performance than the DLC film have been required. Particularly in the case of magnetic recording media, the distance between a read-write head and a medium has been required to be reduced in connection with an increase in recording density, and there has been required a protection film which is thin, but has excellent sliding resistance performance.

Method using carbon ions are known for forming a harder and more delicate carbon film. According to such method, carbon or hydrocarbon gas is decomposed by a plasma, and a film is formed by controlling the energy of carbon ions or hydrocarbon ions thus occurring. At this time, it is necessary to exclude deposition of neutral atoms/radicals and fine particles as much as possible, in order to achieve excellent film quality. One such known method is a filtered cathodic arc (FCA) method (see Japanese Patent Publication JP-A-2002-285328)

Referring to FIG. 1, according to the FCA method, a striker 8 is used to start arc discharge between a cathode 6 having a deposition material 7 mounted therein and an anode 5 under vacuum. A part of the deposition material 7 vaporizes at a local area (cathode spot) and forms plasma 11 containing deposition material ions together with neutral atoms/molecules, radicals and fine particles. Only charged electrons and deposition ions in the plasma 11 are accelerated by an electric field applied between the anode 5 and the cathode 6, and led to a substrate 2 in a film-forming chamber 1 by a magnetic field of a solenoid coil 4 to thereby prevent contamination of the neutral atoms/molecules, radicals and fine particles into the film. Specifically, the electrons and the deposition material ions are led along the lines of magnetic force created by the curved solenoid coil 4, and arrive at the substrate 2. On the other hand, non-charged vaporized materials go in straight lines, unaffected by the electric and magnetic fields, and thus they do not arrive at the substrate 2. When carbon is used as the deposition material, a film of a material called as tetrahedral amorphous carbon (ta-C) is formed. The ta-C film is very hard, and has a hardness larger than DLC. Therefore, it is expected to be used as a protection film of a magnetic recording medium or magnetic read-write head.

Furthermore, there is disclosed a method of manufacturing a high-purity and excellent film by preventing direct impingement of electrons and ions occurring in a plasma chamber against an object to be treated in a plasma CVD method using ECR (see Japanese Patent Publication JP-A-6-188206). According to this method, a shielding member is equipped between a plasma high-density area and a substrate in a plasma chamber to prevent the impingement of ions and electrons against the substrate as would damage a coating by the impingement concerned. This method is different from the method using carbon ions in that film formation is carried out by neutral active species, which are generated by the electrons occurring in the plasma in the film-forming chamber. That is, this method is used to form diamond crystal films and amorphous Si films, and ion impingement causes deterioration of the characteristics of these films. Conversely, the invention uses ions, and is suitable for the film formation of ta-C. Furthermore, see Japanese Patent Publication JP-A-6-188206 discloses that the shielding member is preferably non-magnetic material, and that using a solenoid coil around the film-forming chamber magnetic field is generated so as to spread an electron stream from the plasma chamber, thereby forming a film having a larger area.

Furthermore, there has been developed a plasma treatment apparatus in which, in order to prevent pollution by a cathode material component discharged from a cathode, a bucket type magnetic field is formed around the apparatus and a shielding member is disposed between the cathode and a treatment substrate (see Patent Publication JP-A-7-41952). In this apparatus, the cathode material component discharged from the cathode is shielded by the shielding member, and plasma is led to the treatment substrate by the bucket type magnetic field, whereby a uniform plasma treatment can be performed. In this apparatus, it is neither disclosed nor suggested that the shielding member is a magnet.

However, as shown in FIG. 1, the FCA method has a filter portion 3 containing a curved solenoid coil 4, and thus the apparatus has a large-scale structure. For example, the length of the filter portion 3 is increased to about lm in some apparatuses. Furthermore, the vaporized material 7 is not disposed at the front side of the substrate 2, and thus the symmetry (uniformity) of the film formed on the substrate 2 is degraded. Furthermore, a power source 9 for the solenoid coil is needed in addition to a power source 10 for arc discharge. In addition, a lot of fine particles occur because arc discharge is used, so that these fine particles may impinge against the inner wall of the filter portion 3 and scatter therefrom, thereby degrading the properties of the film achieved. Accordingly, there is a need for a method of forming a film having higher symmetry (uniformity) and an excellent characteristic by using a more compact apparatus.

### OBJECT AND SUMMARY OF THE INVENTION

In order to solve the above problem and meet the need, an object of the invention is to provide a method and an apparatus for forming a film by only ions. More specifically, an object of the invention is to provide a method and an apparatus for forming a hard carbon film.

The invention relates to a method of disposing a shielding member formed of a magnet between a plasma source and a substrate and forming a film. By supplying gas-type raw material to the plasma source, a film can be formed on the substrate on the basis of the principles of the plasma CVD method. Here, the plasma source is hidden by the shielding member, and disposed so that it is not viewed from the substrate. Particularly, it is preferable that a rotation symmetry is used as the shielding member, and the axis of the rotation is disposed in a direction linking the plasma source and the substrate. The magnet serving as the shielding member is disposed so that one of the magnetic poles thereof faces the plasma source and the other magnetic pole faces the substrate. Furthermore, a magnet maybe further disposed at the side of the substrate opposite to that of the shielding member. The pressure in the film-forming process is set to 1 Pa or less, and a bias voltage may be applied to the substrate.

According to the above means, the plasma source can be disposed at the front side of the substrate, the symmetry of the film thus formed is enhanced, and the distance between the plasma source and the substrate can be shortened to about several tens of centimeters. Furthermore, a permanent magnet may be used as the shielding member, and no power source for generating the magnetic field is needed.

According to the method of the invention, the shielding member formed of a magnet is disposed between the plasma source and the substrate, and a film can be formed by only ions of raw material gas in plasma. In the method of the invention, the plasma source can be disposed at the front side of the substrate, and film formation can be performed with higher symmetry and higher uniformity as compared with the FCA method. Furthermore, a permanent magnet is used as the shielding member, and thus a power source for supplying power to a solenoid coil which is indispensable for the FCA method is not required.

Furthermore, according to the method of the invention, gas-type raw material is used as in the case of the normal plasma CVD method, and thus the occurrence of many fine particles due to arc discharge can be avoided. As in the case of the FCA method, the acceleration energy of the ions of the raw material gas can be controlled by a bias voltage applied to the substrate, and a hard carbon coating can be formed.

The hard carbon coating achieved by the method and apparatus of the invention is effectively used as a coating of a sliding resistant member or wear resistant member for various kinds of metal molds, mechanical parts, tools, etc., and as a protection film for a magnetic recording medium or magnetic recording head.

### BRIEF DESCRIPTION OF THE DRAWINGS

FIG. 1 is a cross-sectional view showing an example of a film-forming apparatus used in an FCA method.

FIG. 2 is a cross-sectional view showing an example of a film-forming apparatus used in a plasma CVD method according to the invention.

FIGS. 3A to 3D are diagrams showing cross-sections along the rotational axis of a rotation symmetry shielding member used in the method of the invention, wherein FIG. 3(A) shows a cross section of a shielding member having a cone-cylinder connected shape, FIG. 3(B) shows a cross section of a shielding member having a cylindrical shape, FIG. 3(C) shows a cross section of a shielding member having a double-cone shape, and FIG. 3(D) shows a cross section of a shielding member having a oval shape.

FIG. 4 is a cross-sectional view showing an example of a film-forming apparatus in which a second magnet is provided at the back side of a substrate holder, which is used in another method of the invention.

### DETAILED DESCRIPTION OF THE PREFERRED EMBODIMENTS

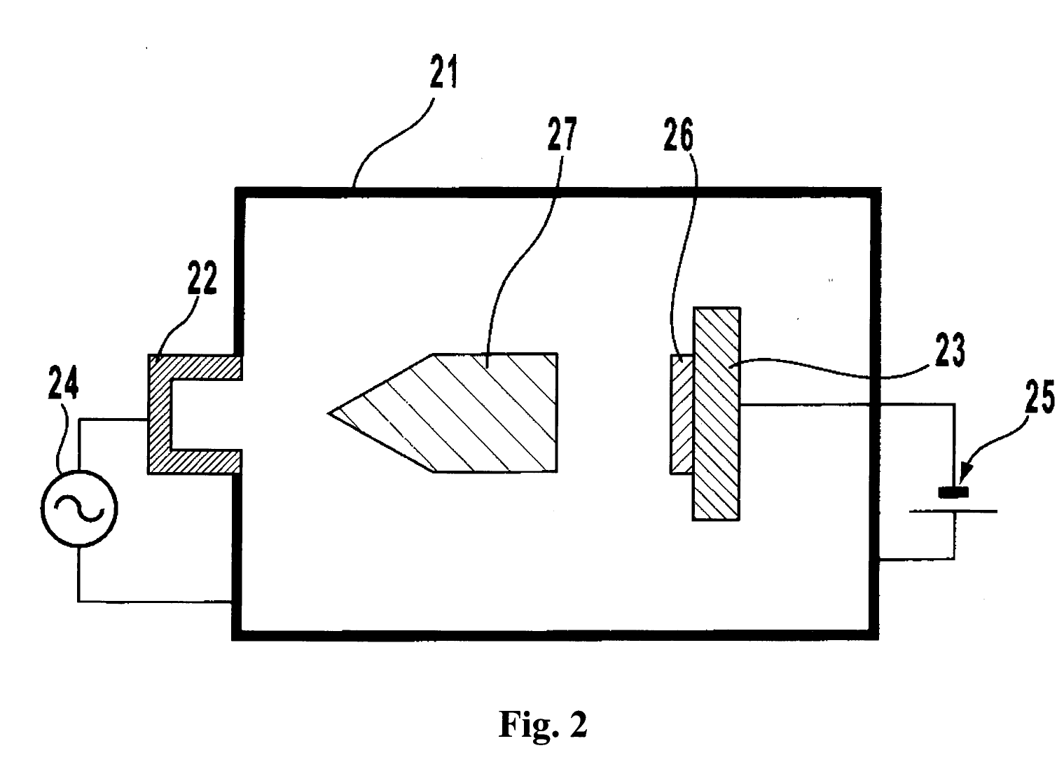

Embodiments according to the invention will be described hereunder with reference to the accompanying drawings. FIG. 2 is a diagram showing an example of the construction of a plasma CVD apparatus used in this invention. A plasma source 22 is provided in part of a wall of a vacuum chamber 21. A substrate holder 23 for holding a substrate 26 is provided within the vacuum chamber 21. The plasma source 22 is connected to a high-frequency power source 24, and the substrate holder 23 is connected to a DC power source 25. Furthermore, a shielding member 27 is disposed between the plasma source 22 and the substrate holder 23 so that the plasma source 22 cannot be viewed from the substrate 26.

The vacuum chamber 21 includes a structure having a gas introducing port and an exhaust port (not shown), which is known for the technique concerned. Preferably, the vacuum chamber 21 is electrically grounded.

The plasma source 22 of the invention includes a hollow cathode type electrode. The plasma source 22 is electrically insulated from the vacuum chamber 21. In order to form a film having a uniform thickness on the substrate 26, the plasma source 22 is disposed so as to face the substrate holder 23.

The substrate holder 23 may designed in any structure known in the technique concerned, which holds the substrate 26 so that the substrate 26 faces the plasma source 22. The holder 23 may be equipped with means for applying a bias voltage as occasion demands. The substrate holder 23 may be equipped with no substrate heating means.

The substrate 26 may be a glass substrate, a ceramic substrate, an Si substrate, a hard metal substrate, a magnetic recording medium having a recording layer formed thereon or the like. The substrate 26 may be designed in a flat shape, or may be designed in a cubic shape required to sliding resistant members or wear resistant members for various kinds of metal molds, mechanical parts, tools, etc.

The shielding member 27 may be a permanent magnet or an electromagnet. In order to avoid a necessity of any power source for generating a magnetic field, the shielding member 27 is preferably a permanent magnet. In this invention, in order to lead electrons and ions of raw material gas generated in the plasma source to the substrate, it is preferable that one of the magnetic poles of the shielding member is disposed to face the plasma source 22, and the other pole is disposed to face the substrate holder 23 (substrate 26).

The magnet forming the shielding member 27 may be formed of any material known in the technique concerned which contains alnico based material, Fe—Cr—Co based material, ferrite based material or rare earth type material (samarium cobalt type (SmCo₅, Sm₂Co₁₇ or the like), Nd—Fe type or the like). It is preferable that a magnet having a residual magnetic flux density of 0.1T or more is used as the shielding member 27 of the invention to effectively induce a plasma. The shielding member 27 of the invention may be manufactured by molding the above material in a proper shape and then magnetizing it. Alternatively, the shielding member 27 may be manufactured by forming a rod-shaped magnet of the above material and then attaching a soft-magnetic material (silicon steel, soft ferrite or the like) to the tips of the magnetic poles of the magnet. The surface thereof may be coated with non-magnetic ceramic, polymer, metal or the like to prevent it from being damaged by plasma.

When the shielding member 27 is formed using an electromagnet, it is formed by winding a conducting wire around a non-magnetic material (Al or the like) or soft magnetic material (silicate steel, soft ferrite or the like) having a desired shape and then connecting it to a DC power source. When the electromagnet is used, the material and the voltage to be applied are selected so that the electromagnet has a magnetic flux density of 0.1T or more at the magnetic poles thereof.

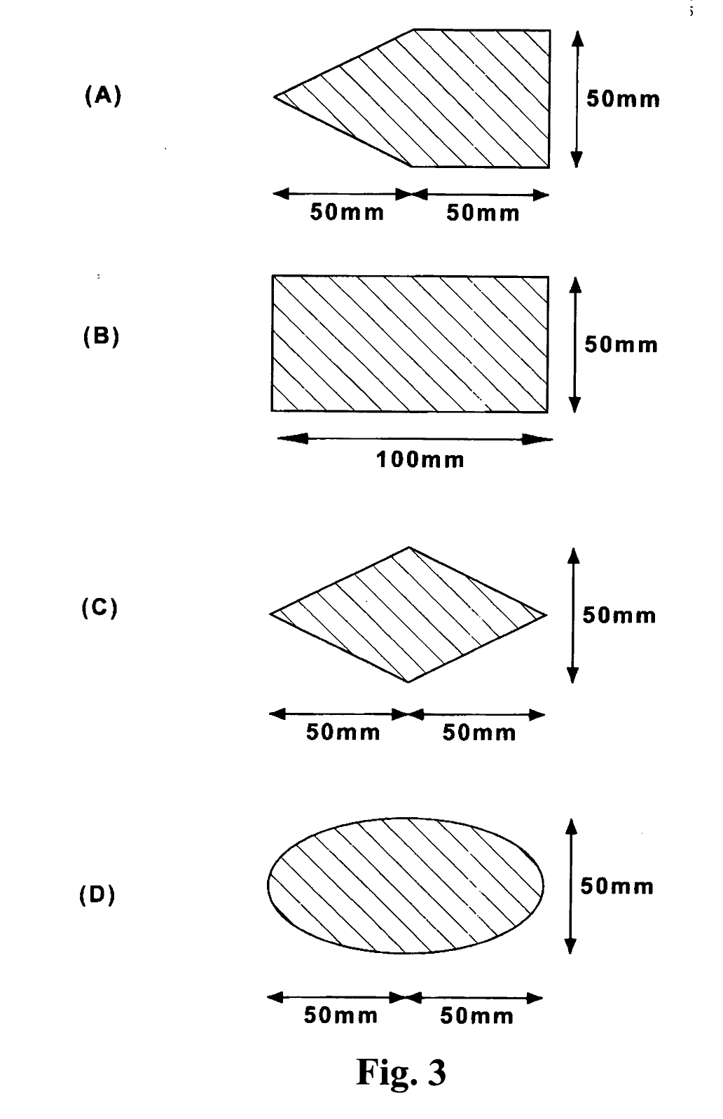

The shielding member 27 is disposed between the plasma source 22 and the substrate 23, and designed to have such a shape that the plasma source 22 is not viewed from the substrate 26. In order to form a film having a uniform thickness on the substrate 26, it is preferable that the shielding member 27 has a highly symmetric cross section when viewed from the substrate 26, and more preferably has a rotation symmetry whose rotational axis corresponds to the axis linking the plasma source 22 and the substrate holder 23. FIG. 3 is a cross-sectional view taken along the rotational axis of the shielding member 27. FIG. 3(A) shows a shielding member designed in such a shape that the cross section thereof has a combined shape of a rectangle and a triangle and a cylinder is joined to the bottom surface of a circular cone. Likewise, FIG. 3(B) shows a shielding member designed in a cylindrical shape having a rectangular cross section, FIG. 3(C) shows a shielding member designed in a double-conical shape having a rhombic cross section, and FIG. 3(D) shows a shielding member designed in a oval shape having an elliptic cross section. The maximum diameter of the shielding member 27 is dependent on the diameter of the substrate 26 on which a film will be formed, the arrangement position of the shielding member 27 (the distance from the substrate 26 and the distance from the plasma source 22), etc. It may be properly selected under the condition that the plasma source 22 cannot be viewed from the substrate 26.

The raw material gas is introduced into the vacuum chamber 21 from the gas introducing port (not shown) provided to the vacuum chamber 21, under the control of a gas flow control device. The raw material gas becomes plasma under high-frequency discharge from the plasma source 22. Any material which is known to form a desired film in the technique concerned may be used as the raw material gas. For example, when a carbon coating is formed, hydrocarbon gas such as ethylene, methane, acetylene, toluene, benzene, propane or the like may be used.

The plasma contains the ions of the raw materials and also neutral atoms and radicals. In this invention, the neutral atoms and the radicals are prevented from arriving at the substrate 26 by the shielding member 27. However, without a magnetic field, neither can the ions of the raw material gas to be formed as a film on the substrate 26 arrive at the substrate 26. Therefore, according to the method of this invention, the ions of the raw material are led to the substrate 26 using the shielding member 27 as a magnet and generating magnetic field around the shielding member 27.

When magnetic field occurs in the vacuum chamber 21, electrons move along the lines of magnetic flux while making a cyclotron-like motion spiraling around the magnetic flux, and the ions of the raw material gas follow the electrons so that electrical neutrality is maintained. With this effect, the plasma has a characteristic of moving along the magnetic flux as a whole. Accordingly, when a magnet is disposed around a treatment chamber as disclosed in the previously mentioned Patent Publication JP-A-6-188206 to form a spreading magnetic field, the plasma is far away from the substrate. On the other hand, the plasma can be positively led to the substrate by forming the shielding member 27 with the magnet according to the invention.

Furthermore, it is preferable that the pressure in the vacuum chamber 21 during the film-forming process is set to 1 Pa or less. By setting the pressure as described above, the mean free path of the plasma (particularly, the ions of the raw material gas) can be sufficiently lengthened, and thus the ions of the raw material gas can arrive at the substrate without being scattered, so that a uniform film can be formed.

A negative voltage may be applied to the substrate holder 23 to lead the ions of the raw material gas to the substrate as occasion demands. The voltage to be applied is preferably set to −1000 to 0 V. Particularly, it is preferably set the voltage to −400 to 0 V to form a hard ta-C film. By using such a voltage, ions moving at a proper speed impinge against a film that has been already formed, so that a graphite component (sp² composite carbon) is selectively sputtered or converted to a diamond component (sp³ composite carbon) in the carbon film, thereby forming the ta-C film.

Furthermore, according to the plasma CVD method used in the invention, a lot of fine particles that occur in the method using arc discharge, such as the FCA method, can be prevented from occurring, and thus the present method is effective to form a film having an excellent characteristic such as uniformity or the like.

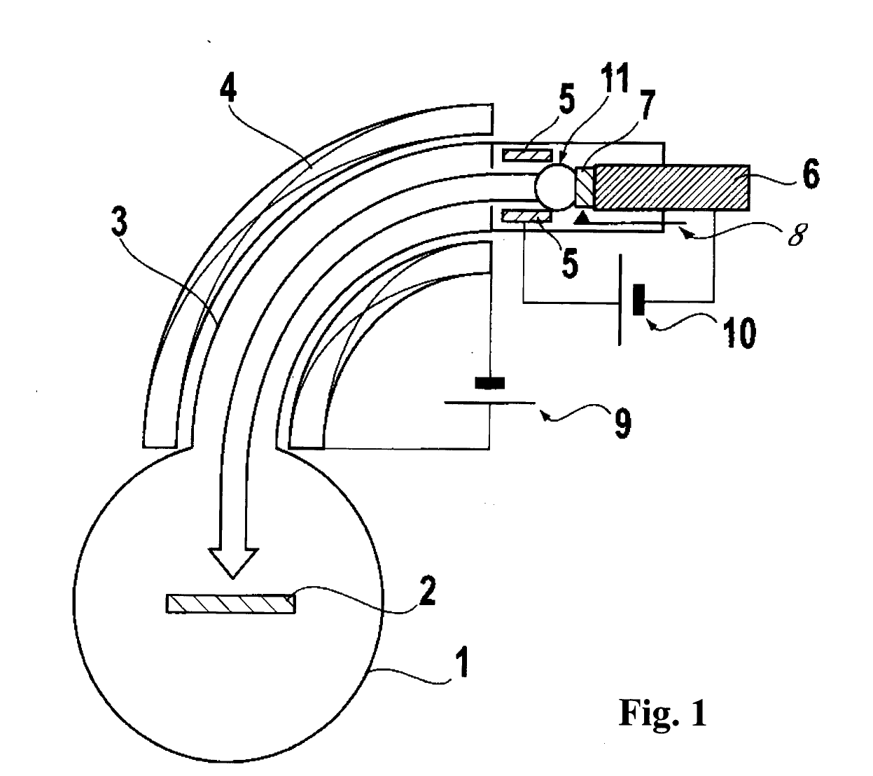

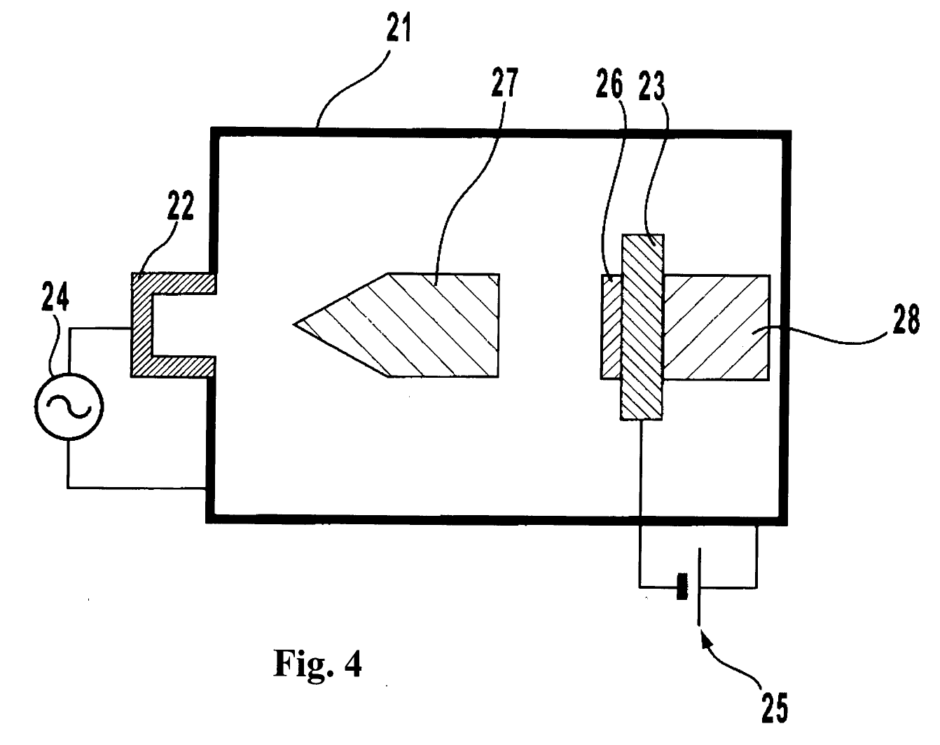

Another embodiment of the invention will be described with reference to FIG. 4. In the apparatus of FIG. 4, a second magnet 28 is further disposed on the back surface of the substrate holder 23 of the apparatus of FIG. 1 (on the surface at the side of the holder 23 opposite to that of the plasma source) The second magnet 28 is disposed so that the center thereof is coincident with the center of the substrate holder 23 and one of the magnetic poles thereof is disposed at the substrate holder 23 side while the other magnetic pole is disposed at the opposite side. The direction of magnetization occurring in the second magnet 28 is coincident with the direction of magnetization occurring in the shielding member 27. That is, when the magnetic pole of the shielding member 27 that is disposed so as to confront the plasma source 22 is the N-pole, the magnetic pole of the second magnet 28 at the substrate holder 23 side also is set to be the N-pole. The second magnet 28 may be a permanent magnet or an electromagnet; however, preferably it is a permanent magnet to avoid the necessity of power for generating magnetic field. The second magnet 28 may be formed using the material of the shielding member 27 described above. It is effective that the second magnet 28 has a (residual) magnetic flux density of 0.1T or more to effectively lead the plasma (particularly, the ions of the raw material gas) to the substrate 26. When a coating is formed using the apparatus of FIG. 4, the coating can be also formed under the same film-forming condition as when the apparatus of FIG. 1 is used.

### EXAMPLES

(Embodiment 1)

A carbon film was formed using the plasma CVD apparatus shown in FIG. 2. An Si substrate 26, 50 mm in diameter, was secured onto a substrate holder 23, and disposed at the front side of the plasma source 22 so that the distance between the substrate 26 and the plasma source 22 was equal to about 25 cm. As the shielding member 27, a cone-cylinder joined body, formed of alnico and having a cross section as shown in FIG. 3(A), was used. The residual magnetic flux density at the tip of the apex of the cone was equal to about 1T. The diameter of the bottom surface of the cone and the cylinder of the joint body was equal to 50 mm, and the height of the cone and the cylinder was equal to 50 mm. The apex of the cone of the joint body was disposed at a position of about 5 cm from the plasma source. The cone side of the shielding member 27 was set to as the N-pole and disposed so as to face the plasma source 22, and the bottom surface of the cylinder at the opposite side was set to be the S-pole and disposed so as to face the substrate 26. The shielding member 27 was electrically floated.

Subsequently, ethylene gas of a flow rate of 5 cc/min was introduced as a raw material gas into the vacuum chamber 21, and the pressure in the vacuum chamber was set to 0.1 Pa. One hundred watts (100 W) of high-frequency power (frequency of 13.56 MHz) was applied to the plasma source, and film formation was carried out for one hour to form a carbon film on the Si substrate. The hardness of the carbon coating thus achieved was measured using the NanoIndenter.

(Embodiment 2)

A carbon coating was formed on an Si substrate using the same method as that applied to Embodiment 1, except that a voltage of −100V was applied to the substrate holder 23.

(Embodiment 3)

A carbon coating was formed on an Si substrate using the same method as applied in the Embodiment 1, except that a voltage of −200V was applied to the substrate holder 23.

### Comparative Example 1

The film formation was carried out using the same method as in the Embodiment 1, except that a non-magnetic Al shielding member having the same shape was used in place of the shielding member 27 of alnico. In this case, no carbon coating was formed on the Si substrate.

### Comparative Example 2

A carbon coating was formed on an Si substrate using the same method as the Embodiment 1, except that no shielding member 27 was used.

### Comparative Example 3

A carbon coating was formed on an Si substrate using the same method as the comparative example 2, except that a voltage of −200V was applied to the substrate holder 23.

### Comparative Example 4

The film formation was carried out using the same method as the embodiment 1 except that a voltage of +100V was applied to the substrate holder 23, however, no carbon coating was formed on the Si substrate.

### Comparative Example 5

The film formation was carried out using the method Embodiment 1, except that the pressure in the vacuum chamber 21 was set to 1 Pa; however, no carbon coating was formed on the Si substrate.

FIRST TABLE
film formation using cone-cylinder joint body

| | | | | COM- | COM- |
|---|---|---|---|---|---|
| | | | | PARA- | PARA- |
| | | | | TIVE | TIVE |
| | EMBODI- | EMBODI- | EMBODI- | EXAM- | EXAM- |
| | MENT 1 | MENT 2 | MENT 3 | PLE 2 | PLE 3 |
| SUBSTRATE | 0 | −100 | −200 | 0 | −200 |
| BIAS | | | | | |
| VOLTAGE (V) | | | | | |
| FILM | 80 | 100 | 100 | 500 | 450 |
| THICKNESS | | | | | |
| (nm) | | | | | |
| HARDNESS | 30 | 40 | 40 | 5 | 15 |
| (GPa) | | | | | |

As is apparent from the above embodiments, a hard carbon film having an excellent hardness of 30 GPa can be achieved using the magnet having the shape corresponding to a cone-cylinder joint body as the shielding member. When the non-magnetic shielding member of the comparative example 1 was used, no carbon film was formed on the substrate, and thus it is apparent that use of a magnet as the shielding member is effective to lead plasma (particularly, the ions of the raw material gas for film formation) to the substrate. The hardness of the carbon coating when no shielding member was used was equal to 5 Gpa, and thus it was apparent that the carbon coating achieved was like a polymer. Furthermore, the hardness of the carbon coating of the comparative example 3 when no shielding member was used was equal to 15 GPa, which was within the hardness range of the DLC film; however, it is remarkably lower than the hardness of the coating achieved in the Embodiment 1. These results were estimated to indicate that neutral atoms, radicals, etc. from the plasma source impinged against the substrate during the film formation process and lowered the film quality because no shielding member was used.

Furthermore, as shown in the Embodiment 2 and the Embodiment 3, the film thickness was increased and the film hardness was enhanced by applying a negative bias voltage to the substrate holder 23. As compared with the comparative example 4 in which no carbon film was formed by applying a positive bias voltage, the negative bias voltage is more effective to lead the plasma (particularly, the ions of the raw material gas for film formation) to the substrate. Furthermore, it is apparent that the component contributing to the film formation is carbon ions.

Furthermore, in the comparison example 5 in which the pressure in the vacuum chamber was increased, no carbon film could be formed on the substrate. This is estimated to occur because the increase of the pressure shortened the mean free path of the ions of the raw material gas and thus the film formation suffered a scattering effect.

### Comparative Example 6

A carbon coating was formed using the FCA apparatus shown in FIG. 1. A carbon block of 99.999% purity, 30 mm in diameter and 30 mm in thickness, was used as a cathode target 7. The cathode 6 and the anode 5 were equipped with a water cooling type cooling means to prevent over-heating during arc discharge. A magnetic filter 3 used an arcuate stainless pipe, 76 mm in diameter extending over a 90 degree arc with a 300 mm radius of curvature, as a core pipe, and a copper wire coated with polyester coating of 2 mm in diameter was wound around the core pipe to provide a filter coil 4. The number n of turns per unit length of the coating copper wire was set to 1000 turns/m. An Si substrate 2 was mounted in a film-forming chamber 1 to be vertical to the axial direction of the magnetic filter. While a voltage of 40V was applied between the cathode and the anode, the striker 8 was brought into contact with the surface of the cathode target 7, and an arc discharge was started. A cathode voltage during arch discharge was equal to −25V, and discharge current was set to 120 A. A predetermined current was supplied to the magnetic filter coil 4 so that the internal magnetic field in the magnetic filter was equal to 0.013T. The film formation was carried out for five minutes, and a Ta-C film having a film thickness of about 200 nm was achieved.

However, the position at which the maximum film thickness is provided deviated from the center of the magnetic filter to the inner peripheral side, and deviated from the center of the substrate to the right side by about 25 mm in FIG. 1. As the maximum film thickness position was far away from this latter position, the film thickness was reduced, and reduced by about 50% on the circumference of a circle of 15 mm in radius. However, the reduction of the film thickness was greater at the inner peripheral side of the filter, and the film thickness was reduced to be less at the inner peripheral side than at the outer peripheral side by about 10% on the circumference of 15 mm in radius. On the other hand, with respect to the carbon coating achieved in the Embodiment 1 and the comparative example 2, the center of the film thickness distribution was the center of the substrate, and the variation of the film thickness on the circumference of 15 mm in radius was also within 5% of the maximum film thickness. This was because the film-forming mechanism in the Embodiment 1 and the comparative example 2 was axially symmetric. On the other hand, it is apparent that the symmetry of the FCA apparatus was lost because it had the magnetic filter portion, and thus the film thickness distribution was affected by the loss of the symmetry.

(Embodiment 4)

A carbon coating was formed on an Si substrate using the same method as the Embodiment 1, except for the following: A shielding member having a cylindrical shape of 100 mm in height which has a bottom surface of 50 mm in diameter as shown in FIG. 3(B) was used in place of the shielding member 27 having the shape corresponding to the cone-cylinder joint body used in the Embodiment 1. The intensity and position of the magnet of the shielding member were set to the same as the Embodiment 1.

(Embodiment 5)

A carbon coating was formed on an Si substrate using the same method as the embodiment 1 except for the following: A shielding member having a double-cone shape in which the bottom surface thereof was 50 mm in diameter and each cone was 100 mm in height as shown in FIG. 3(C) was used in place of the shielding member 27 having the shape corresponding to the cone-cylinder joint body used in the Embodiment 1. The intensity and position of the magnet of the shielding member were set to the same as the Embodiment 1.

(Embodiment 6)

A carbon coating was formed on an Si substrate using the same method as the Embodiment 1 except for the following: A shielding member having a flat-spherical shape of 50 mm in maximum diameter and 100 mm in length as shown in FIG. 3(D) was used in place of the shielding member 27 having the shape corresponding to the cone-cylinder joint body used in the Embodiment 1. The intensity and position of the magnet of the shielding member were set to the same as the Embodiment 1.

SECOND TABLE
Effect of the shape of the shielding member

| | EMBODI- | EMBODI- | EMBODI- | COMPARATIVE |
|---|---|---|---|---|
| | MENT 1 | MENT 4 | MENT 5 | EXAMPLE 6 |
| FILM | 80 | 5 | 150 | 180 |
| THICKNESS | | | | |
| (nm) | | | | |
| HARDNESS | 30 | 30 | 30 | 30 |
| (GPa) | | | | |

As is apparent from the above embodiments, the ions of the raw material gas can be more effectively led to the substrate by the shielding member having the cone-cylinder joint body shape than the shielding member having the cylindrical shape, and the shielding member having the double-cone shape and further the shielding member having the flat-spherical shape are even more effective.

(Embodiment 7)

A coil having a turning density of 4 turns/cm was wound around the side surface of the non-magnetic Al shielding member used in the comparative example 1, and connected to a DC power source of 10 A to form an electromagnet. A carbon coating was formed on an Si substrate using the electromagnet according to the same method as the comparative example.

The carbon coating thus achieved had a film thickness of 30 nm. It therefore is apparent that the ions of the raw material gas can be also led to the substrate using the electromagnet.

(Embodiment 8)

A carbon coating was using the plasma CVD apparatus shown in FIG. 4, in which the second magnet 28 was disposed at the back side of the substrate holder 23. The second magnet 28 was designed as a cylindrical magnet of 50 mm in diameter and 100 mm in length. The bottom surface of the second magnet was set to be the N-pole, and the bottom surface concerned was brought into contact with and secured to the substrate holder 23 (that is, the plasma surface side was set to the N-pole). The other bottom surface of the second magnet was set to the S-pole.

A carbon coating was formed on an Si substrate using the same apparatus and method as the Embodiment 1, except that the second magnet 28 was provided.

The film thickness of the carbon coating thus achieved was equal to 120 nm. Therefore, comparing the film thickness of 80 nm achieved in the Embodiment 1, it is apparent that the second magnet 28 disposed at the back side of the substrate holder 23 has a function of leading the plasma (particularly, the ions of the raw material gas) more effectively.

This application claims the foreign priority benefit of Japanese patent application JP 2003-2700173, filed Jul. 1, 2003, the disclosure of which is incorporated herein by reference.

1. A method of forming a film, comprising the steps of:
disposing a shielding member of a first magnet between a plasma source and a substrate;
producing a plasma from the plasma source CVD method;
decomposing a raw material in the plasma; and
forming a film from the decomposed material.

2. The film-forming method according to claim 1, wherein the step of decomposing includes decomposing a hydrocarbon gas, and the step of forming a film includes forming a carbon film

3. The film-forming method according to claim 1, wherein the steps of producing, decomposing and forming are executed under a pressure of no greater than 1 Pa.

4. The film-forming method according to claim 1, further comprising the step of applying a voltage to the substrate.

5. The film-forming method according to claim 4, wherein the step of applying a voltage includes applying a negative voltage to the substrate.

6. The film-forming method according to claim 1, wherein the step of disposing a shielding member includes disposing the shielding member so that the plasma source is not viewed from the substrate.

7. The film-forming method according to claim 1, wherein the step of disposing a shielding member includes disposing the shielding member so that one of the magnetic poles thereof is disposed to confront the plasma source, and the other is disposed to confront the substrate.

8. The film-forming method according to claim 1, wherein the shielding member has a rotational symmetry, and an axis of rotation in a direction linking the plasma source and the substrate.

9. The film-forming method according to claim 8, wherein the shielding member has a diameter larger than a diameter of the substrate.

10. The film-forming method according to claim 1, wherein the shielding member is a permanent magnet.

11. The film-forming method according to claim 1, further comprising the step of disposing a second magnet at a side of the substrate opposite to that of the first magnet, the second magnet having a magnetization direction that is the same as that of the first magnet.

12. A film-forming apparatus, comprising:
a plasma source for decomposing a raw material,
a substrate holder for holding a substrate on which the decomposed material is deposited, and
a magnetic shielding member disposed between the plasma source and the substrate.

13. The film-forming apparatus according to claim 12, further comprising means for applying a voltage to the substrate.

14. The film-forming apparatus according to claim 13, wherein the voltage is a negative voltage.

15. The film-forming apparatus according to claim 12, wherein the shielding member a shielding member is disposed so that the plasma source is not viewed from the substrate.

16. The film-forming apparatus according to claim 12, wherein the shielding member has two magnetic poles and is disposed so that one of the magnetic poles confronts the plasma source and the other magnetic pole confronts the substrate.

17. The film-forming apparatus according to claim 12, wherein the shielding member has a rotational symmetry, and the axis of the rotation of the shielding member is in a direction linking the plasma source and the substrate.

18. The film-forming apparatus according to claim 17, wherein the shielding member has a diameter larger than a diameter of the substrate.

19. The film-forming apparatus according to claim 12, wherein the shielding member is a permanent magnet.

20. The film-forming apparatus according to claim 12, further comprising a second magnet disposed at a side of the substrate opposite to that of the shielding member, wherein the second magnet has a magnetization direction that is the same as that of the first magnet.
